(19) United States
(12) Patent Application Publication
(10) Pub. No.: US 2003/0234948 A1
(43) Pub. Date: Dec. 25, 2003

(54) Print data management system, data structure thereof, method thereof and program thereof

(75) Inventor: Yoshitomo Sasaki, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/340,701

(22) Filed: Jan. 13, 2003

(30) Foreign Application Priority Data
Jun. 25, 2002 (JP) 2002-184663

(51) Int. Cl. G06F 15/00; G06F 3/12; H04N 1/50; H04N 1/40

(52) U.S. Cl. 358/1.13; 358/1.15; 358/2.1

(57) ABSTRACT

A system for managing print data of a print target document has a module recording first print specification data common in the print target document, a module recording second print specification data common in a predetermined portion of the print target document, and a print content recording module recording print contents of the print target document on basis of every predetermined portion.

### BACKGROUND OF THE INVENTION

The present invention relates to a format of print data.

With a complete establishment of the environment for connecting to the Internet, printers have come to support a protocol typified by IPP (Internet Printing Protocol) capable of interactive communications with a network. Owing to such a protocol, the printer comes to have a function of accessing a print target on the network such as the Internet etc.

Some of these printers incorporate a function by which the printer communicates directly with a server, obtains printable data and prints the obtained data, in addition to the conventional function of receiving print data from a personal computer and printing the print data. Herein, the printable data is data printed directly by inputting the same data to the printer as well as being data based on interface specifications through which the printer is connected to an external device.

With such an operation that the printable data are set on the server, thereby it may be possible to scheme to improve an efficiency of printing document data consisting of a plurality of pages such as an operation manual, a catalogue and a specification document of an apparatus and often used as a paper document.

Further, the printable data described above has great advantages in terms of its management in which the printable data that is already structured in a printable format therefore does not require document creating application software and is hard to falsify.

As for the print data saved on the server, however, it is desirable that all pages of the data be stored so that it is utilized for printing later on. Further, in the case of saving the printable data on the server, it is required that the data be saved in a format suited to the characteristic of the printer for printing the data.

Moreover, with a spread of color-adapted printers offered in recent years, a trend is that documents to be created are more color-oriented. Therefore, in the case of saving the printable data, it is considered that two categories of data such as data for colors and data for a monochrome are stored matching with the characteristic of the printer.

Then, when printing by the printer, any one of the two categories of data such as the color printer oriented data (which is called color data) and a monochrome printer oriented data (which is called monochrome data) for one document, may be selected and printed. An alternative assumption is that only the color data is prepared on the server, and the printer receiving the data converts the color data into the monochrome data and prints the converted data.

### SUMMARY OF THE INVENTION

In the case of the operation described above, a problem is that a printable data size corresponding to one document increases. Further, in the case of the operation of saving only the color data on the server, the data having a large capacity flows on a communication line at all times, and consequently there arises a problem in which a load on the communication line increases with the result that a communication cost rises. Another problem arises as an inconvenient aspect, where in a process till completing print process is time-consuming.

Further, when storing the two categories of print data such as color data and the monochrome data, each category of data needs a data file, and it is required that the two file names be managed as a pair of files. This results in a large load on the file management.

It is a primary object of the present invention, which was devised to obviate the above problems inherent in the prior art, to provide a print data saving technology excellently capable of reducing a data size, exhibiting a high print performance and conducting a well-designed print data management.

To accomplish the above object, according to one aspect of the present invention, a system for managing print data of a print target document includes a module recording first print specification data common in the print target document, a module recording second print specification data common in a predetermined portion of the print target document, and a print content recording module recording print contents of the print target document on basis of every predetermined portion.

Herein, the predetermined portion implies, for example, one page of a document, a portion from a delimiter to the next delimiter of the document, a chapter, a paragraph etc. of the document. Thus, the present system records the print data in a way that segments the print data into function-by-function data elements such as the first print specification data, the second print specification data and the print content for every predetermined portion.

Preferably, the print content recording module may record a multi-color print content and a monochrome print content with respect to a multi-color print target document, and may record the monochrome print content with respect to a monochrome print target document.

Thus, the present system decreases the data size as much as the multi-color print content with respect to the monochrome print target document.

Preferably, the system may further include a module converting the multi-color print content into the monochrome print content, and a module transferring the print content to a printing device, wherein the print content recording module may record the multi-color print content with respect to the multi-color print target document, and the converting module, if the print target document contains the multi-color print content and if the printing device is incapable of effecting a multi-color print, may convert this multi-color print content into the monochrome print content.

As described above, the present system, if the printing device is incapable of effecting the multi-color print, converts the multi-color print content into the monochrome print content, and transmits the converted print content to the printing device. Therefore, the data size to be transmitted can be reduced as compared with the case the color print content is converted into the monochrome print content on the side of the printing device.

Preferably, the system may further include a module judging whether the print content is updated for each predetermined portion, a module extracting an updated portion from the print content of the print target document after being updated, a module replacing a data portion of the recorded print content with the updated portion, and recording and managing the replacement thereof, and a module transferring the print content replaced with the updated portion to the printing device. Thus, the present system is capable of extracting and printing only the updated portion.

According to the present invention, any one of the components described above may be actualized as a program running on a computer or as a data structure.

According to another aspect of the present invention, there is provided a method by which the computer and other device, machine etc. executes any one of the processes described above.

According to still another aspect of the present invention, there is provided a program or a data structure that makes the computer or other device, machine etc. actualize any one of the functions, the steps or the processes.

According to a further aspect of the present invention, there is provided a recording medium readable by the computer and other device, machine etc., on which the above program or data structure is recorded.

As explained above, according to the present invention, there is provided the print data saving technology excellently capable of decreasing the data size, exhibiting the high print performance and conducting the well-designed data management.

### BRIEF DESCRIPTION OF THE DRAWINGS

FIG. 1 is a diagram showing a system architecture of an information system in a first embodiment of the present invention;

FIG. 2 is a diagram showing data selecting procedures for having print data printed;

FIG. 3 is a diagram showing a structure of the print data;

FIG. 4 is a diagram showing a data structure of a common format field;

FIG. 5 is a diagram showing a data structure of a page header filed;

FIG. 6 is a diagram showing an example of a color/monochrome converting process of converting color data into monochrome data;

FIG. 7 is a flowchart (1) showing processing procedures in the first embodiment;

FIG. 8 is a flowchart (2) showing the processing procedures in the first embodiment;

FIG. 9 is a flowchart (3) showing the processing procedures in the first embodiment;

FIG. 10 is a diagram showing a concept of a print data replacing process when a print target document is updated; and

FIG. 11 is a flowchart showing a printing process in a second embodiment.

### DETAILED DESCRIPTION OF THE PREFERRED EMBODIMENTS

Preferred embodiments of the present invention will hereinafter be described with reference to the accompanying drawings.

<<First Embodiment>>

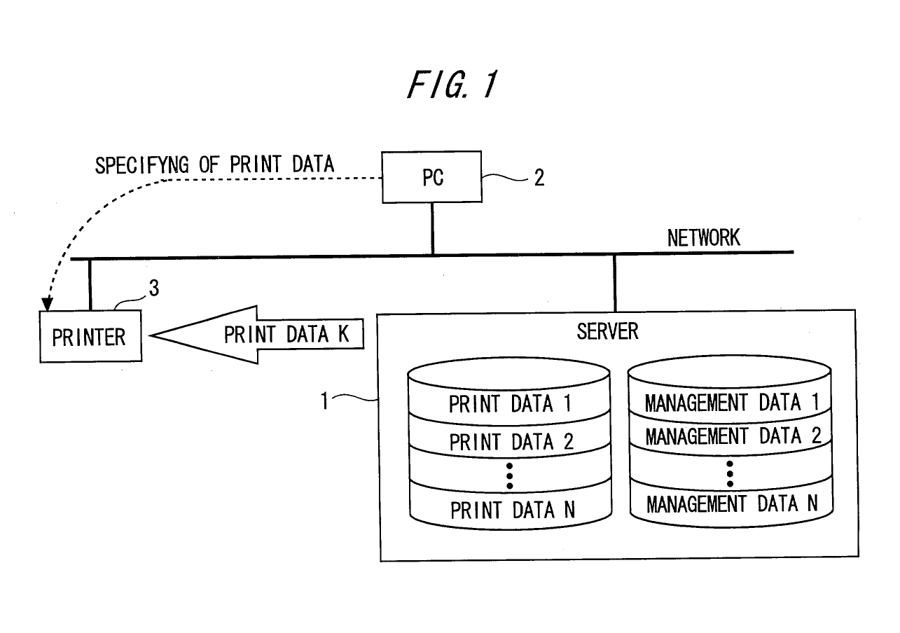

An information system in a first embodiment of the present invention will hereinafter be discussed in conjunction with FIGS. 1 through 9.

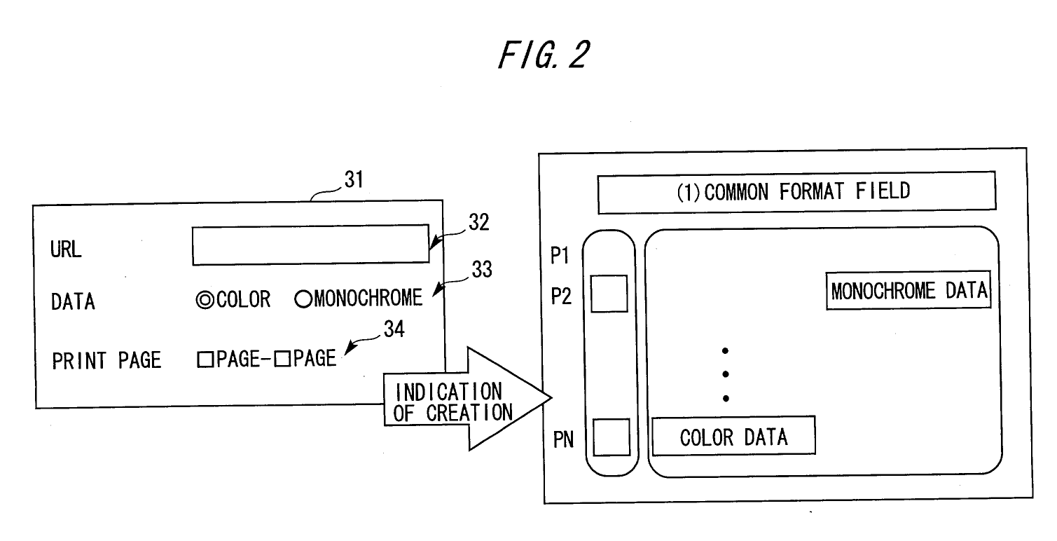

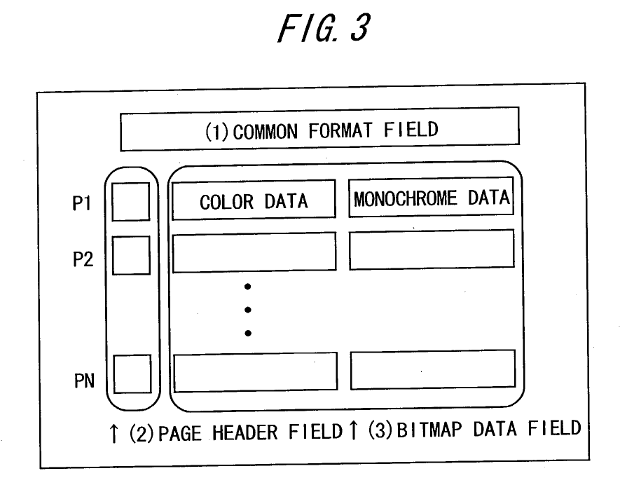

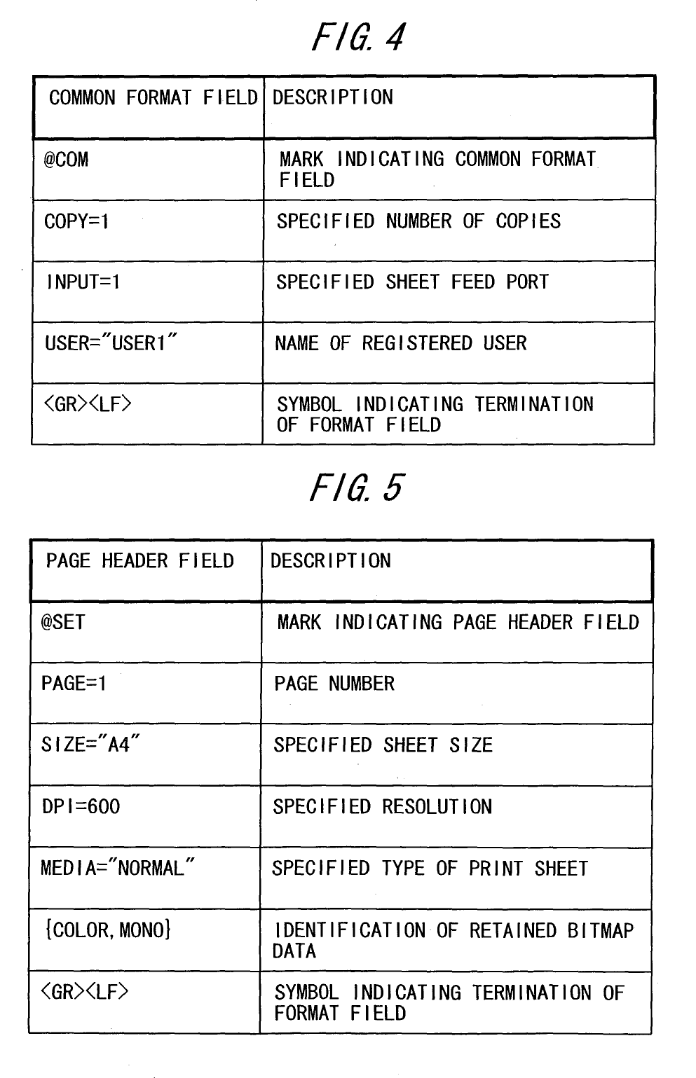

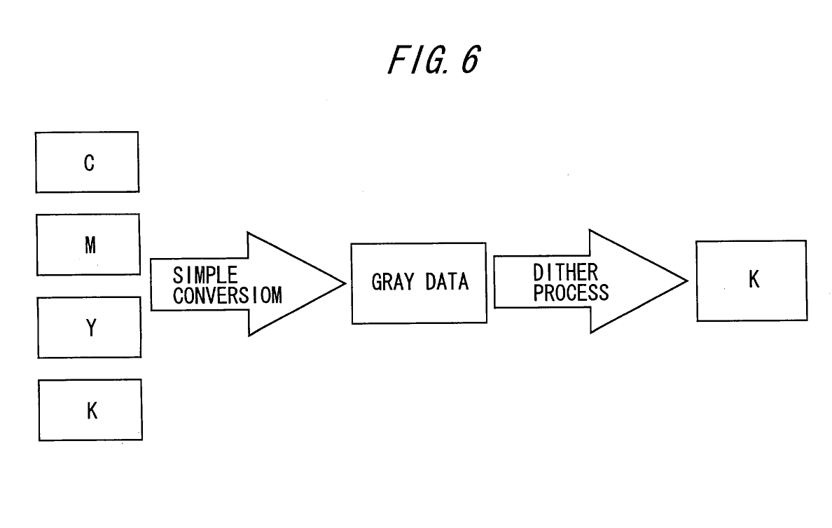

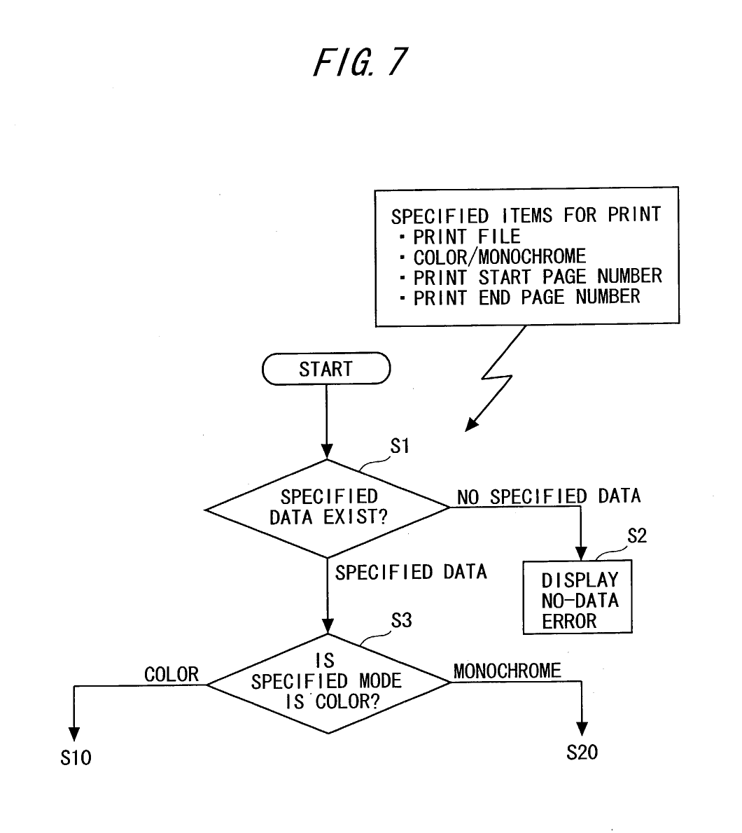

FIG. 1 is a diagram showing a system architecture of the information system in the first embodiment. FIG. 2 is a diagram showing data selecting procedures in which a printer 3 operates to print pieces of print data saved in a server 1 illustrated in FIG. 1. FIG. 3 is a diagram showing a structure of the print data in the present information system. FIG. 4 is a diagram showing a data structure of a common format field shown in FIG. 3. FIG. 5 is a diagram showing a data structure of a page header filed shown in FIG. 3. FIG. 6 is a diagram showing an example of a color/monochrome converting process of converting color data into monochrome data. FIGS. 7 through 9 are flowcharts each showing processing procedures in the first embodiment.

<Outline of Functions>

FIG. 1 shows the system architecture of the present information system. This information system is configured by connecting a personal computer 2, a printer 3 and a server 1 to each other via a network.

Each of the server 1 and the personal computer is a typical computer including a telecommunication board, of which components are broadly known, and hence their explanations are herein omitted.

Further, the printer 3 is also a typical printer incorporating a communication function with the network. Accordingly, in the first embodiment, a printing method itself of the printer is not limited, and the printer 3 may involve the use of a variety of types of printers such as a laser beam printer, an inkjet printer, a thermal printer etc.

According to the present information system, the server 1 saves the print data formatted so that the data can be inputted intactly to the printer 3. The data that can be inputted intactly to the printer 3 are data readable by the printer 3 without converting the data format as well as being data defined by input interface specifications of the printer 3.

As illustrated in FIG. 1, plural sets of print data (print data 1 through N) are stored in the server 1. Further, according to the present information system, management data sets (1 through N) are retained mapping to the respective print data sets (1 through N). The management data set contains, for example, an update history of the print data.

The user of the present information system accesses the printer 3 via the personal computer 2, then specifies the print data (e.g., the print data K), and gives an indication of executing the print. Thereupon, the printer 3 accesses the server 1 via the network to read the specified print data K, and print the print data K. Thus, according to the present information system, the print data accumulated in the server 1 are transferred directly to the printer 3 via the network and printed.

FIG. 2 is the diagram showing a operation screen 31, displayed on the personal computer 2, of the printer 3, and an outline of processing when manipulating on this operation screen. This printer 3 incorporates a function as a Web server and provides the screen 31 illustrated in FIG. 2 to the personal computer 2.

This screen 31 contains a print target specifying box 32, a print data color specifying box 33 and a print page specifying box 34. The print target specifying box 32 is used to specify storage location of the print target data and a file name thereof as a URL (Uniform Resource Locator).

The print data color specifying box 33 contains radio buttons attached with color and monochrome labels, wherein an option of the color print or the monochrome print is specified. The print page specifying box 34 is used to specify print target pages in the print data.

After making these settings, upon indicating to execute printing, the printer 3 requests the server 1 for the print data specified. At this point of time, the personal computer 2 giving the indication of printing remains disconnected from the printer 3.

On the other hand, the server 1 stored with the print data structures the print data in response to the request given from the printer 3. Now, it is herein assumed that the color print be specified as the print data color, and pages “2” through “n” be specified as the print pages.

In this case, the server 1, with the data of the first page skipped over, extracts the color data out of the pages “2” through “n” (P2-Pn) and transmits the extracted data to the printer 3. Further, with respect to the pages of only the monochrome data, the server 1 may extract the monochrome data.

The printer 3 receives the data transmitted from the server 2 and executes the printing process. Note that a piece of information about the number of print copies may be transmitted to the printer to effect printing of these copies, or the print data may be created by repeating for the specified number of copies. Thus the data may be created in a way that matches with a characteristic of the printer.

<Data Structure>

FIG. 3 shows a structure of the print data. As shown in FIG. 3, in the present information system, the print data format is segmented into data elements according to the respective functions and thus stored in the server 1. To be more specific, the print data stored in the server 1 has a common format field ((1) in FIG. 3) , a page header field ((2) in FIG. 3) and a compressed bitmap data field ((3) in FIG. 3).

The common format field contains items of data common to the print data, such as pieces of information about the number of print copies, a sheet feed port and so on. Further, the page header field contains items of information common within one page, such as a sheet size etc. These items of information may be used as they when printing and may also be restructured when printing, and the printing may be thus performed.

The bitmap data field contains depiction information about the print target page. The bitmap data field is structured such as <vertical pixel count (of print data)><horizontal pixel count><vertical pixel size><horizontal pixel size><pixel data array>.

According to the first embodiment, when a print target document as a source of the print data contains color information, the element <pixel data array> contains both of a color pixel data array and a monochrome pixel data array.

The color pixel data array consists of 4-bit-tuples for specifying ON/OFF on respective color planes of C, M, Y and K. This pixel data array is called color data or a color bitmap.

Further, the monochrome pixel data array is defined as a bit string for specifying ON/OFF about K-information, and is called monochrome data or a monochrome bitmap.

The server 1 in the present information system transmits to the printer 3 the print data containing the data (the color data or the monochrome data) suited to the print mode (the color pint or not) specified when printing or in accordance with the characteristic of the printer 3, the above data being retained in the bitmap field. Note that if only the monochrome data exist therein, in the bitmap data field thereof, one set of data is utilized in common to both of the color and the monochrome (only the monochrome data may be retained, and the color data are unnecessary).

FIG. 4 shows the data structure of the common format field. In the first embodiment, the common format field contains an identifier (“@com” in FIG. 4) identifying the common data field, a specified number of print copies, a specified sheet feed port (it is specified which sheet feed port the sheet is supplied from), a name of registered user and a termination symbol (<CR><LF> in FIG. 4) of the format field. Thus, the common format field contains common items of information for a single printing process of the print target document.

FIG. 5 shows the data structure of the page header field. In the first embodiment, the page header field contains an identifier (“@SET” in FIG. 5) identifying the page header field, a page number, a specified sheet size, a specified resolution, a specified type of the print paper, a piece of identifying information (COLOR or MONO in FIG. 5) indicating which data, the color data or the monochrome data, the bitmap data retained in the page concerned contain, and a termination symbol (<CR><LF> in FIG. 5) of the page header field. Thus, the page header field contains common items of information within one print target page.

<Color=>Monochrome Conversion>

The present information system incorporates a function of generating the monochrome data from the color data on the server 1.

FIG. 6 shows a data conversion method in this case. This type of conversion method is exemplified such as executing a pseudo conversion (which is shown as a “simple conversion” in FIG. 6) of 1-bit data of each of C, M, Y and K into gray data as shown in FIG. 6, effecting a dither process thereon and generating monochrome 1-bit data, and so forth.

In the simple conversion shown in FIG. 6, a numerical value of 4 bits specifying ON/OFF on each plane of C, M, Y and K is converted into a numerical value indicating a density of the gray data. This type of conversion can be actualized by, for instance, processes of a program including a conversion table or a conversion formula for converting a bit pattern corresponding to each of Y, M, C and K of one pixel into a bit pattern corresponding to the gray data.

Further, the dither process may be defined as a process for expressing the gray data in a combination of 2-dimensional dot patterns. With this dither process executed, the monochrome data is eventually structured of combinations of dot patterns that specify black.

<Operation>

FIGS. 7 through 9 show the processing steps when printing according to the present information system. In the first embodiment, when printing, the user accesses the printer 3 from on the personal computer 2, and gives the indication of printing. Responding to this indication, the printer 3 sends the request for the print data to the server 1, thereby starting a process in FIG. 7. In this case, the user specifies a print data (a print target file), a distinction between the color print and the monochrome print (color/monochrome), a print start page and a print end page.

In this process, the server 1 at first judges whether there exist the data (the print data specified in the printer 3 by the user) specified in the printer 3 (S1). Then, if the specified print data do not exist, the server 1 sends to the printer 3 a message indicating that there is no data. Upon receiving this message, the printer 3 transmits an error message indicating no data to the personal computer 2 of the user. This error message is accumulated in, e.g., a message queue of the personal computer 2 or in history information. When the user displays a print state or a print history on the personal computer 2, that error message thereof is displayed (S2).

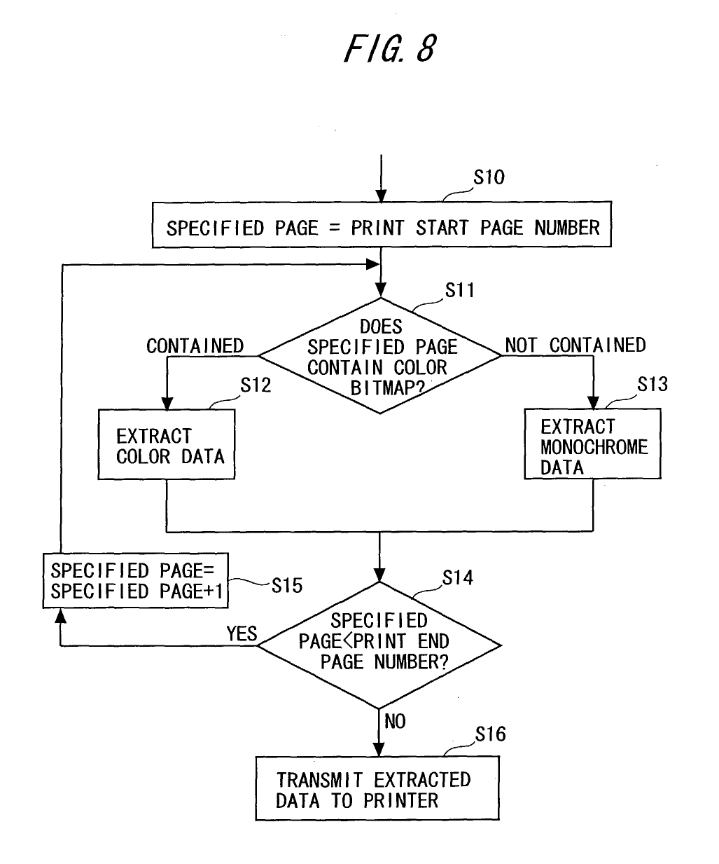

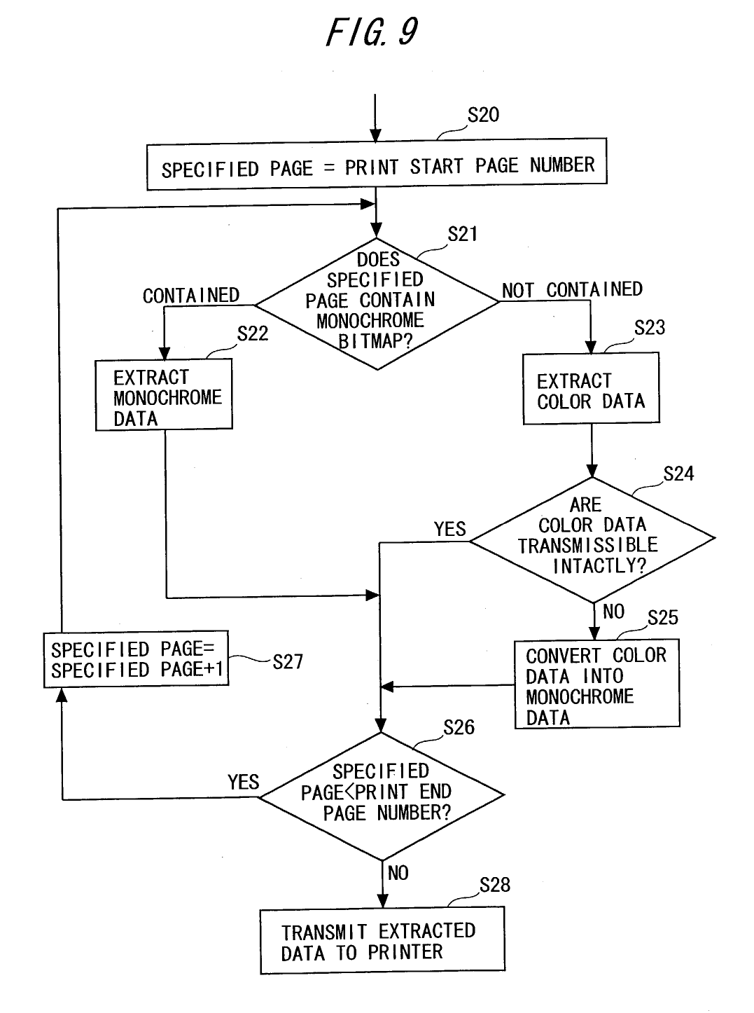

While on the other hand, when judging in S1 that the specified data exist, next the server 1 judges whether the specified print mode is color print or not (S3). Then, if the specified print mode is the color print, the server 1 advances the control to S10 in FIG. 8. On the other hand, if the specified print mode is the monochrome print, the server 1 advances the control to S20 in FIG. 9.

FIG. 8 shows a process when the color print is specified. In this process, the server 1 sets a page number of the print start page in a parameter for controlling the present print page (which is called a specified page) (S10).

Next, the server 1 judges whether or not the color bitmap exists in the specified page (S11). It is judged from the information in the page header field (that specifies [the color print or the monochrome print]) in FIG. 5) whether the color bitmap exists or not.

If the color bitmap exists in the specified page, the specified page is a color page, and hence the server 1 extracts the color data (see FIG. 3) from the print data (S12). Whereas if the color bitmap does not exist in the specified page, the specified page is a monochrome page, and therefore the server 1 extracts the monochrome data (see FIG. 3) (S13).

Next, the server 1 judges whether the specified page reaches the print end page (S14). If the specified page does not reach the print end page, the server 1 increments the specified page by 1 (S15), and returns the control to S11. Whereas if the specified page reaches the print end page, the server 1 transmits the extracted print data to the printer 3 (S16).

FIG. 9 shows a process in the case of the monochrome print being specified in S3 in FIG. 7. In this process also, the server 1, to start with, sets the print start page in the parameter for controlling the specified page (S20).

Next, the server 1 judges whether the monochrome bitmap exists in the specified page (S21). If the monochrome bitmap exists in the specified page, the specified page is a monochrome page, and hence the server 1 extracts the monochrome data from the print data (S22).

Whereas if the monochrome bitmap does not exist in the specified page, the specified page is the color page, and therefore the server 1 extracts the color data (S23) Next, the server 1 judges whether the color data are transmissible as they are (S24). The case where the color data are transmissible as they are, implies a case where the printer 3 incorporates a conversion function of converting from the color bitmap into the monochrome bitmap. A piece of information showing whether the printer 3 incorporates this conversion function, maybe transferred when the printer 3 requests the server 1 for the print data.

Then, in the case where the color data are transmissible as they are, the server 1 advances the control to S26. Whereas if the color data are not transmissible as they are, the server 1 converts the color data into the monochrome data (S25), and advances the control to S26.

Then, the server 1 judges whether the specified page reaches the print end page (S26). If the specified page does not reach the print end page, the server 1 increments the specified page by 1 (S27), and returns the control to S21. Whereas if the specified page reaches the print end page, the server 1 transmits the extracted print data to the printer 3 (S28). Responding to this process, the printer 3 prints the print data transmitted.

As discussed above, according to the present information system, the server 1 retains the print data for one print process of the single document in a way that registers the same items of print data separately in the common format field, the page header field and the bitmap data field. Further, the bitmap data field retains the data for the color print and the data for the monochrome print. It is therefore possible to select and effect any one of the color print and the monochrome print in the state where the print data are accumulated in the server 1.

Moreover, the print data contain the color data and the monochrome data with respect to one common format field and one page header field, and hence, as compared with the conventional method of storing individually the color data and the monochrome data, the data size can be reduced by structuring the common format field and one page header field in common. Further, according to this print data format, there is no necessity of managing the data file in a way that sets the color and monochrome data files as a pair, thereby lessening the load on the file management.

Further, in the first embodiment, if the monochrome print is specified in the state where only the color data are retained, the server 1 executes the conversion from the color data into the monochrome data, and transfers the converted monochrome data to the printer 3. Accordingly, the data size (traffic) transferred on the network can be reduced as compared with the case of converting the color data into the monochrome data by the printer 3.

<Modified Example>

According to the first embodiment, the personal computer 2 indicates to the printer 3 the location of the data file to be printed, the file name, the print mode (the color print or not) and the page to be printed. Further, the location and the file of the print data are specified by the URL address system. The embodiment of the present invention is not, however, limited to the specifying procedures described above, and other specifying methods may also be adopted depending on a protocol that supports (the data communications). Further, the indication of the color print may be automatically determined based on the type of the printer used for printing.

In the first embodiment discussed above, when the print target page is the color document, both of the color data and the monochrome data are retained as the print data. As a substitute for this, however, the color data may be retained as the print data corresponding to the color document, and the monochrome data may be retained as the print data corresponding to the monochrome document. Then, in the case of printing the color data in monochrome, as done in S25 in FIG. 9, the monochrome data after being converted from the color data may be printed. This scheme enables a further reduction in the data size retained in the server.

According to the first embodiment, the print data are retained in the way that segments the same data in the common format field, the page header field and the page-by-page bitmap field. The embodiment of the present invention is not, however, confined to this data structure. For example, the header information may be provided in every category portion other than page. For instance, the header information may be provided for every aggregation of a plurality of pages and for every piece of document delimiter information (a sentence delimiter, a chapter, a paragraph) that is not directly related to the page.

<<Second Embodiment>>

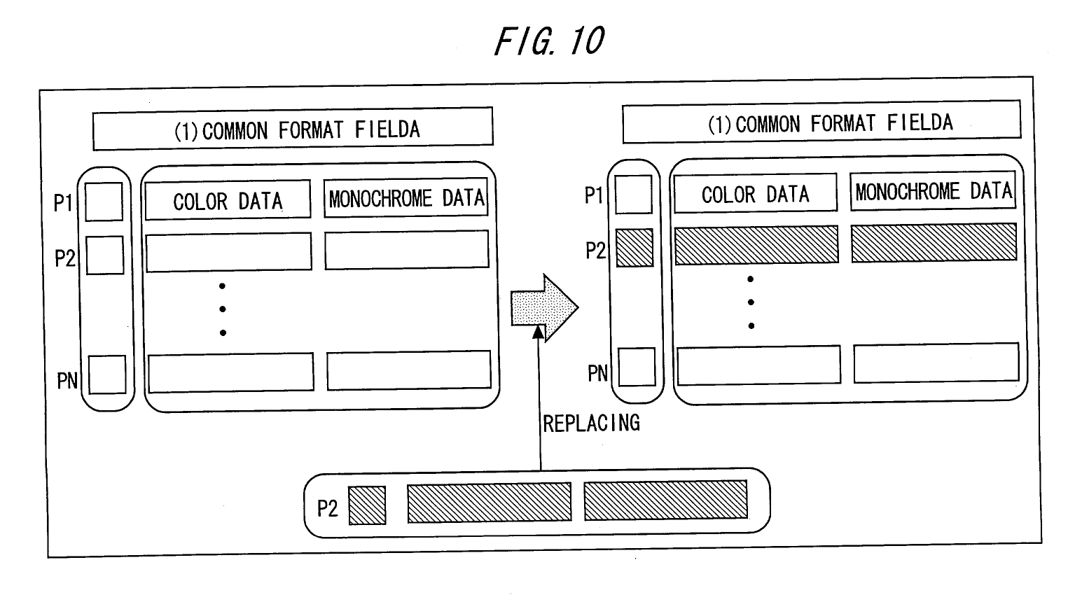

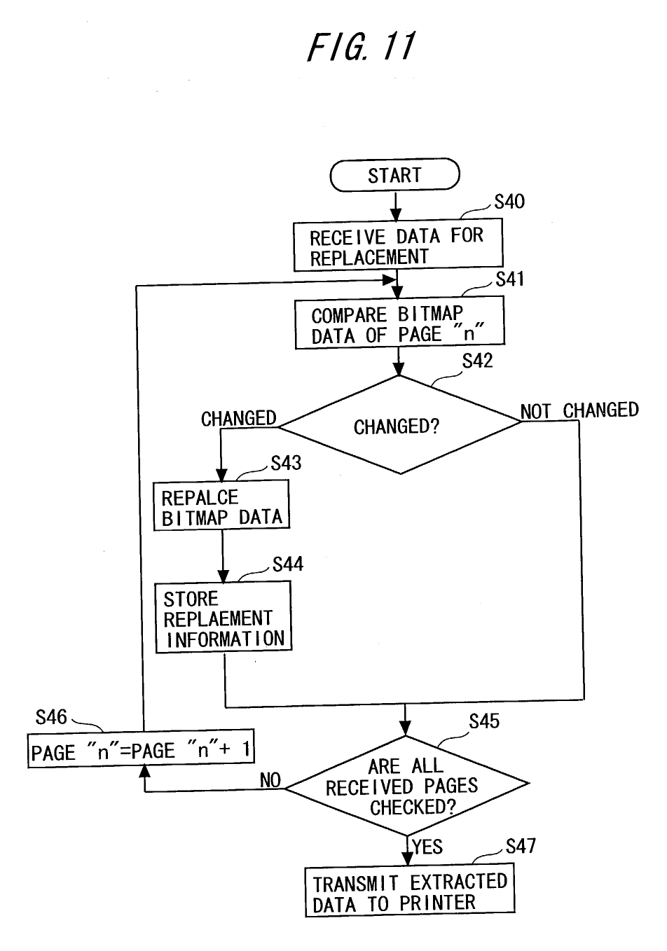

A second embodiment of the present invention will hereinafter be described referring to FIGS. 10 and 11. FIG. 10 is a diagram showing a concept of a print data replacing process when the print target document is updated. FIG. 11 is a flowchart showing a printing process in the second embodiment.

The first embodiment has exemplified the information system in which the print data are saved in the server 1 in the way that segments the same items of print data in the common format field, the page header field and the bitmap field, and these items of data are directly transmitted to and printed by the printer.

The discussion in the second embodiment will be focused on a function of replacing, on the occasion of storing the post-updated document in the server 1, change pages of the print document from the pre-updated document and generating the print data corresponding to the post-updated document. Other configurations and operations are the same as those in the first embodiment. Therefore, the same components are marked with the same numerals, and their repetitive explanations are omitted.

FIG. 10 shows the concept of the print data replacing process. This process is that for example, in a document creation program, a print module for this document creation program refers to an update history and generates the print data of only the updated pages.

Then, the personal computer 2 (the document creation program) registers only the data of the updated pages in the server 1, whereby only the minimum data required may be transmitted to the serve 1.

Moreover, the server 1 may retain a history of the updated pages for every print data. For example, the server 1 may retain a latest updated date/time per page, a checksum per page, or a difference between the post-updated page and the pre-updated page.

This kind of history may be recorded in the management data (1 through N) mapping to the print data (1 through N). The server 1 can provide a print-data-formatted database function by retaining management (data) of the change history described above. Further, the server 1 may also provide a function (which may be a function of transmitting only the updated pages to the printing machine 3 from the server 1) of extracting only the updated pages on the basis of the history information described above and printing these extracted pages.

<Modified Example>

The second embodiment has exemplified the scheme that the document creation program installed into the personal computer 2 etc. extracts the updated pages from the updated document and generates the print data of these extracted pages. The embodiment of the present invention is not, however, limited to this scheme. For instance, the server 1 judges whether the pages of the print data are updated, and only the updated pages may be printed by the printer.

FIG. 11 is the flowchart showing the process of the server 1 judging whether the page-by-page updating is carried out, and transmitting only the print pages to the printer 3. In this process, at first, the server 1 receives data for replacement (S40).

Then, the server 1 compares the already-stored bitmap with a received bitmap with respect to the n-th page (n=1, 2, . . . ). Then, the server 1 judges whether there is a change in the bitmap of this page (S42).

If there is the change in the bitmap of this page, the server 1 replaces the bitmap data thereof (S43). Further, this page is saved in the server 1 (S44).

Next, the server 1 judges whether all the received pages are checked (S45). Then, if all the pages are not yet checked, a page number “n” is incremented by 1 (S46). Thereafter, the server 1 returns the control to S41.

Whereas if all the received data are checked, the server 1 transmits the data saved by the process in S44 to the printer 3 (S47).

Through the process described above, the server 1 can transmit only the updated pages of the document edited on the personal computer 2 etc. and can have these updated pages printed by the printer 3.

<<Effects of the Embodiment>>

The information system in the second embodiment is capable of transmitting to the printer the optimal data corresponding to the specification or the function of the printer in use, which contributes to decrease the traffic when in operation. Further, the data structure of the print data shown in the second embodiment enables a reduction in the data size required on the server 1. Moreover, this data structure eliminates the necessity of conducting, for example, the file management in a way that maps the color data file to the monochrome data file, thus facilitating the file management.

Further, the document data are retained page by page, and it is possible to correspond to the process when specifying the print pages without any load on the server process as compared with the case of retaining the data without the data segmentation. Still further, when updating the data on the server 1, it is also possible to replace the data of only the updated pages, which can contribute to enhance an efficiency of the data management.

<<Storage Medium Readable by Computer and Other Devices and Machines>>

A program read by a computer and other devices and machines to actualize any one of the functions described above, may be recorded on a storage medium readable by the computer etc. Then, the computer etc. reads and executes the program on this storage medium, thereby making it possible to provide this function.

Herein, the storage medium readable by the computer etc. includes storage mediums capable of storing information such as data, programs, etc. electrically, magnetically, optically and mechanically or by chemical action, which can be all read by the computer etc. What is demountable out of the computer among those storage mediums may be, e.g., a flexible disk, a magneto-optic disk, a CD-ROM, a CD-R/W, a DVD, a DAT, an 8 mm tape, a memory card, etc.

Further, a hard disk, a ROM (Read Only Memory) and so on are classified as fixed type storage mediums within the computer.

<<Data Communication Signal Embodied in Carrier Wave>>

Furthermore, the above program may be stored in the hard disk and the memory of the computer and other devices and machines, and downloaded to other computers via communication media. In this case, the program is transmitted as data communication signals embodied in carrier waves via the communication media. Then, the computer downloaded with this program can be made to provide the above function.

Herein, the communication media may be any one of cable communication mediums such as metallic cables including a coaxial cable and a twisted pair cable, optical communication cables, or wireless communication media such as satellite communications, ground wave wireless communications, etc.

Further, the carrier waves are electromagnetic waves for modulating the data communication signals, or the light. The carrier waves may, however, be DC signals. In this case, the data communication signal takes a base band waveform with no carrier wave. Accordingly, the data communication signal embodied in the carrier wave may be any one of a modulated broadband signal and an unmodulated base band signal (corresponding to a case of setting a DC signal having a voltage of 0 as a carrier wave).

What is claimed is:

1. A system which manages print data of a print target document, comprising:
a module recording first print specification data common in the print target document;
a module recording second print specification data common in a predetermined portion of the print target document; and
a print content recording module recording print contents of the print target document on basis of every predetermined portion.

2. A system according to claim 1, wherein said print content recording module records a multi-color print content and a monochrome print content with respect to a multi-color print target document, and records the monochrome print content with respect to a monochrome print target document.

3. A system according to claim 1, further comprising:
a module converting the multi-color print content into the monochrome print content; and
a module transferring the print content to a printing device,
wherein said print content recording module records the multi-color print content with respect to the multi-color print target document, and
said converting module, if the print target document contains the multi-color print content and if said printing device is incapable of effecting a multi-color print, converts this multi-color print content into the monochrome print content.

4. A system according to claim 1, further comprising:
a module judging whether the print content is updated for each predetermined portion;
a module extracting an updated portion from the print content of the print target document after being updated;
a module replacing a data portion of the recorded print content with the updated portion, and recording and managing the replacement thereof; and
a module transferring the print content replaced with the updated portion to said printing device.

5. A data structure making a computer function as a system managing print data which has a print target document printed by a printing device, said data structure comprising:
first print specification data defining a common operation of said printing device throughout a printing process of the print target document;
second print specification data defining a common operation of said printing device in a predetermined portion of the print target document; and
print content data recording the print content of the print target document on basis of every predetermined portion.

6. A data structure according to claim 5, wherein said print content data records a multi-color print content and a monochrome print content with respect to a multicolor- print target document, and records the monochrome print content with respect to a monochrome print target document.

7. A data structure according to claim 5, wherein said second print specification data contains information indicating whether the print content of the predetermined portion retains multi-colors or a monochrome or both thereof, and
said print content data records the multi-color print content with respect to the multi-color print target document and, if said printing device is incapable of effecting the multi-color print, make said computer convert the multi-color print content into the monochrome print content.

8. A method executed by a computer to manage print data of a print target document, comprising:
recording first print specification data common in the print target document;
recording second print specification data common in a predetermined portion of the print target document; and
recording print contents of the print target document on basis of every predetermined portion.

9. A method according to claim 8, wherein the recording the print contents involves recording a multi-color print content and a monochrome print content with respect to a multi-color print target document, and recording the monochrome print content with respect to a monochrome print target document.

10. A method according to claim 8, further comprising:
converting the multi-color print content into the monochrome print content; and
transferring the print content to a printing device,
wherein the recording the print contents involves recording the multi-color print content with respect to the multi-color print target document, and
the converting involves, if the print target document contains the multi-color print content and if said printing device is incapable of effecting a multi-color print, converting this multi-color print content into the monochrome print content.

11. A method according to claim 8, further comprising:
judging whether the print content is updated for each predetermined portion;
extracting an updated portion from the print content of the print target document after being updated;
replacing a data portion of the recorded print content with the updated portion, and recording and managing the replacement thereof; and
printing the print content replaced with the updated portion.

12. A storage medium readable by a machine, tangible embodying a program of instructions executable by the machine to perform method steps for making a computer manage print data of a print target document, the method steps comprising:
recording first print specification data common in the print target document;
recording second print specification data common in a predetermined portion of the print target document; and
recording print contents of the print target document on basis of every predetermined portion.

13. A storage medium readable by a machine tangible embodying a program according to claim 12, wherein the recording the print content involves recording a multi-color print content and a monochrome print content with respect to a multi-color print target document, and recording the monochrome print content with respect to a monochrome print target document.

14. A storage medium readable by a machine tangible embodying a program according to claim 12, further comprising:
converting the multi-color print content into the monochrome print content; and
transferring the print content to a printing device,
wherein the recording the print contents involves recording the multi-color print content with respect to the multi-color print target document, and
the converting involves, if the print target document contains the multi-color print content and if said printing device is incapable of effecting a multi-color print, converting this multi-color print content into the monochrome print content.

15. A storage medium readable by a machine tangible embodying a program according to claim 12, further comprising:
judging whether the print content is updated for each predetermined portion;
extracting an updated portion from the print content of the print target document after being updated;
replacing a data portion of the recorded print content with the updated portion, and recording and managing the replacement thereof; and
transferring the print content replaced with the updated portion to said printing device.
